(19) United States
(12) Patent Application Publication
(10) Pub. No.: US 2026/0322537 A1
(43) Pub. Date: Oct. 15, 2026

(54) METHOD AND DEVICE FOR TRANSMITTING DATA IN NEXT GENERATION CELLULAR NETWORK

(71) Applicant: SAMSUNG ELECTRONICS CO., LTD., Suwon-si (KR)

(72) Inventors: Junsuk KIM, Suwon-si (KR); Jihwan KIM, Suwon-si, (KR); Byungwook YOO, Suwon-si (KR); Euichang JUNG, Suwon-si (KR)

(21) Appl. No.: 19/696,524

(22) Filed: Jun. 3, 2026

Related U.S. Application Data
(63) Continuation of application No. PCT/KR2024/096655, filed on Dec. 11, 2024.

(30) Foreign Application Priority Data
Dec. 27, 2023 (KR) 10-2023-0193208
Jan. 26, 2024 (KR) 10-2024-0011958

(51) Int. Cl. H04L 1/1812; H04L 67/131; H04W 52/02; H04W 72/231; H04W 72/232

(52) U.S. Cl. CPC H04L 1/1812; H04L 67/131; H04W 52/0225; H04W 72/231; H04W 72/232

(57) ABSTRACT

An electronic device may include: a memory storing instructions; and at least one processor, wherein the instructions, when executed by at least one processor, cause the electronic device to: identify, based on feedback information corresponding to one or more hybrid automatic repeat request (HARQ) process IDs, a first data block determined not to perform HARQ retransmission (HARQ-less) among one or more data blocks; based on at least one block being identified as the first data block, transmit, to a base station using the first data block, data classified as not performing retransmission; stop monitoring a physical downlink control channel (PDCCH) being executed for retransmitting the HARQ; and switch the electronic device into a sleep state.

### CROSS-REFERENCE TO RELATED APPLICATIONS

This application is a continuation of International Application No. PCT/KR2024/0966655 designating the United States, filed on Dec. 11, 2024, in the Korean Ministry of Intellectual Property Receiving Office and claiming priority to Korean Patent Application Nos. 10-2023-0193208, filed on Dec. 27, 2023, and 10-2024-0011958, filed on Jan. 26, 2024, in the Korean Ministry of Intellectual Property, the disclosures of each of which are incorporated by reference herein in their entireties.

### BACKGROUND

### Field

The present disclosure relates to an operation of a terminal and a base station in a mobile communication system, and for example, to a method and device for transmitting data to be transmitted via a configured grant (CG) resource, in a case where the data has a short transmission time requirement, when a configured grant is configured.

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. It has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

The goal in the early stage of the 5G mobile communication technology is to support services and meet performance requirements for enhanced mobile broadband (eMBB), ultra-reliable low-latency communications (URLLC), and massive machine-type communications (mMTC). To achieve the goal, standardization is underway for beamforming and massive MIMO to mitigate path loss of radio waves and increase a radio wave transmission distances in an ultra-high frequency band, support for various numerologies (such as an operation of multiple subcarrier spacings) and dynamic operation of slot formats for efficient utilization of ultra-high frequency resources, initial access technologies to support multi-beam transmission and broadband, definition and operation of a bandwidth part (BWP), new channel coding methods such as a low density parity check (LDPC) code for large-capacity data transmission and a polar code for highly reliable transmission of control information, L2 pre-processing, network slicing to provide dedicated networks specialized to specific services, etc.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning. Over the past few years, several broadband wireless technologies have been developed to satisfy the growing number of broadband subscribers and to provide more diverse and improved applications and services. Second generation wireless communication systems were developed to provide voice services while ensuring mobility of users. Third generation wireless communication systems support not only voice services but also data services. Fourth generation wireless communication systems were developed to provide high-speed data services. However, the fourth generation wireless communication systems are experiencing difficulties due to a shortage of resources for meeting the increasing demand for high-speed data services. Accordingly, fifth generation wireless communication systems are being developed to meet the increasing demand for various services having diverse requirements, such as high-speed data services, ultra-reliable low-latency applications, and massive machine-type communication. Spectrum utilization efficiency needs to be improved. Since it is highly likely that various services will be supported in a single 5G cellular network, flexible multiplexing of multiple services is required. In addition, system design should consider forward compatibility in order to smoothly add new services in the future.

A need has arisen to address a potential problem that may occur in transmitting data to be transmitted via a configured grant (CG) resource, in a case where the data has a short transmission time requirement, when a configured grant is configured.

### SUMMARY

Embodiments of the disclosure provide a method and device for addressing a problem that may occur in transmitting data to be transmitted via a configured grant (CG) resource, in a case where the data has a short transmission time requirement, when a configured grant is configured for a terminal.

According to an example embodiment, an electronic device may include: a memory storing instructions and at least one processor, comprising processing circuitry, wherein the instructions, when executed by at least one processor, individually or in any combination, cause the electronic device to: identify, based on feedback information corresponding to one or more hybrid automatic repeat request (HARQ) process IDs, a first data block determined not to perform HARQ retransmission (HARQ-less) among one or more data blocks, transmit, to a base station using the first data block, data classified as not performing retransmission based on at least one block being identified as the first data block, stop monitoring a physical downlink control channel (PDCCH) being executed for retransmitting the HARQ, and switch the electronic device into a sleep state.

According to an example embodiment, a method of operating an electronic device may include: identifying, based on feedback information corresponding to one or more hybrid automatic repeat request (HARQ) process IDs, a first data block determined not to perform HARQ retransmission (HARQ-less) among one or more data blocks, transmitting, to a base station using the first data block, data classified as not performing retransmission based on at least one block being identified as the first data block, and stopping monitoring a physical downlink control channel (PDCCH) being executed for retransmitting the HARQ and switching the electronic device into a sleep state.

According to an example embodiment, a non-transitory computer-readable recording medium may include a memory storing instructions which, when executed by at leat one processor, comprising processing circuitry, of an electronic device, individually or in any combination, cause the electronic device to: identify, based on feedback information corresponding to one or more hybrid automatic repeat request (HARQ) process IDs, a first data block determined not to perform HARQ retransmission (HARQ-less) among one or more data blocks, transmit, to a base station using the first data block, data classified as not performing retransmission based on at least one block being identified as the first data block, and stop monitoring a physical downlink control channel (PDCCH) being executed for retransmitting the HARQ and switch the electronic device into a sleep state.

The electronic device according to various example embodiments of the present disclosure may efficiently transmit and receive the data to be transmitted via the configured grant (CG) resource, even in the case where the data has the short transmission time requirement, when the configured grant is configured.

The electronic device according to various eample embodiments of the present disclosure may provide the method for transmitting data without retransmission in the CG scheme resource allocation structure due to the absence of the HARQ feedback, and the framework for performing the same.

The electronic device according to various example embodiments of the present disclosure may reduce the power consumption of the electronic device by optimizing the sleep operation interval from the perspective of the UL transmission of the XR services.

### BRIEF DESCRIPTION OF THE DRAWINGS

The above and othre aspects, features and advantages of certain embodiments of the present disclosure will be more apparent from the following detailed description, taken in conjunction with the accompanying drawings, in which:

FIG. 1 is a block diagram of an eample electronic device in a network environment according to various example embodiments.

FIG. 2 is a block diagram illustrating an example configuration of the electronic device according to various example embodiments.

FIG. 3A is a diagram illustrating a situation in which physical downlink control channel (PDCCH) monitoring is performed in a configured grant (CG)-based resource allocation situation according to comparative example.

FIG. 3B is a diagram illustrating a situation in which the order of data is changed due to a long time required for retransmission in the configured grant (CG)-based resource allocation situation according to a comparative example.

FIG. 4 is a signal flow diagram illustrating a situation in which the electronic device provides an extended reality (XR) service according to various example embodiments.

FIG. 5A is a diagram illustrating an example process of generating identification information in which whether HARQ can be retransmitted for each process ID is written according to various example embodiments.

FIG. 5B is a signal flow diagram illustrating an example base station-based identification information management scheme according to various example embodiments.

FIGS. 5C and 5D are diagrams illustrating an example electronic device-based identification information management scheme according to various example embodiments.

FIG. 6 is a diagram illustrating an example process in which an electronic device distinguishes data blocks that do not require retransmission and performs multiplexing and assembling of XR data according to various example embodiments.

FIG. 7 is a flowchart illustrating an example method for transmitting data by an electronic device according to various example embodiments.

FIG. 8 is a flowchart illustrating an example method for transmitting data by an electronic device according to various example embodiments.

### DETAILED DESCRIPTION

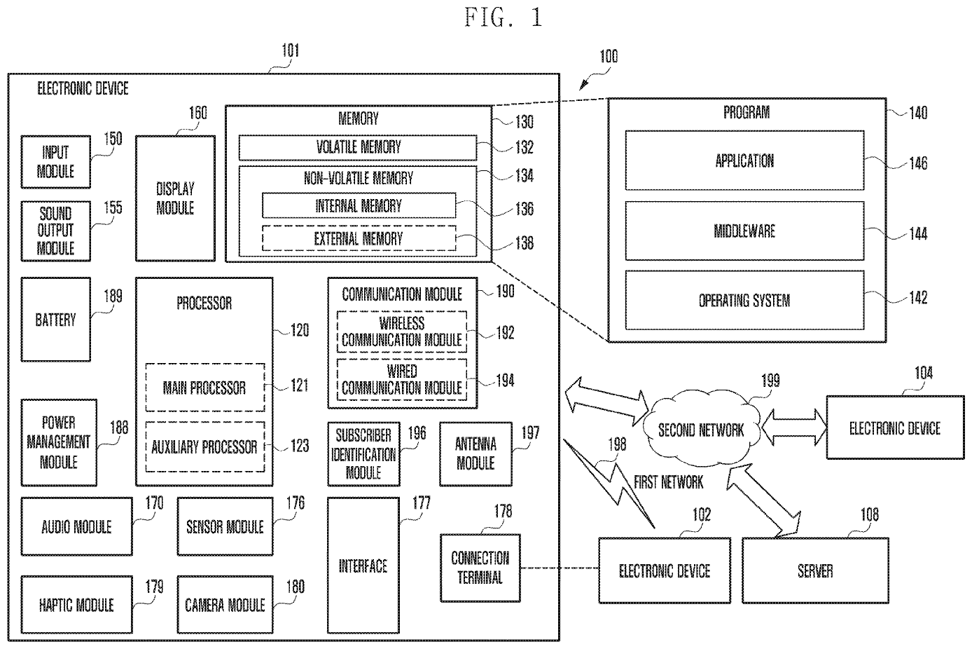

FIG. 1 is a block diagram illustrating an example electronic device 101 in a network environment 100 according to various example embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

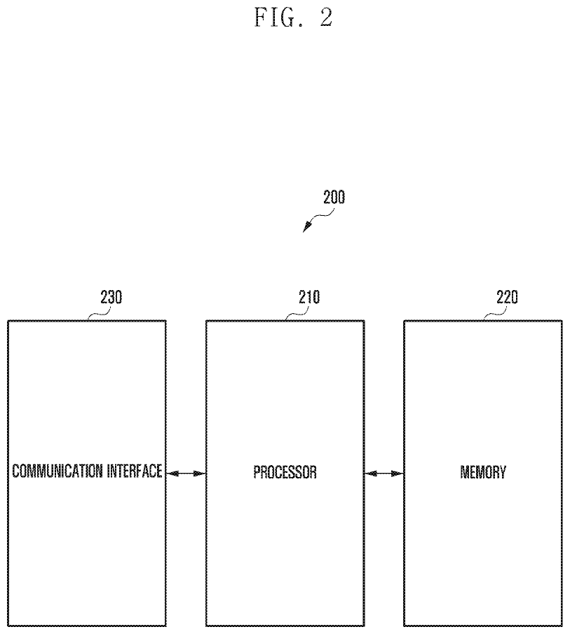

FIG. 2 is a block diagram illustrating an example configuration of the electronic device according to various example embodiments.

Hereinafter, an operation principle of the present disclosure will be described in greater detail with reference to the accompanying drawings. In the following description, when it is determined that the detailed description of the known arts or configurations related to the present disclosure may unnecessarily obscure the gist of the present disclosure, the detailed description thereof may be omitted. Further, the following terms are terms defined in consideration of the functions in the present disclosure and may vary depending on the intention, practice, etc., of users and operators. Therefore, the definitions thereof should be construed based on the contents throughout the disclosure.

In the following description, terms used to identify connection nodes, terms referring to network entities, terms referring to messages, terms referring to interfaces between network entities, terms referring to various pieces of identification information, etc., are examples for convenience of description. Accordingly, the present disclosure is not limited to terms described below, and other terms referring to objects having equivalent technical meanings may be used.

Hereinafter, a base station may refer to an entity that performs resource allocation of a terminal, and may be at least one of a gNode B, an eNode B, a Node B, a base station (BS), a radio access unit, a base station controller, or a node on a network. The terminal may include user equipment (UE), a mobile station (MS), a cellular phone, a smartphone, a computer, or a multimedia system capable of performing a communication function. In the present disclosure, downlink (DL) refers to a wireless transmission path of a signal transmitted from a base station to a terminal, and uplink (UL) refers to a wireless transmission path of a signal transmitted from a terminal to a base station. Although an LTE or LTE-A system may be described below as an example, various embodiments of the present disclosure may also be applied to other communication systems having a similar technical background or channel type. For example, the 5th generation (5G) mobile communication technology (new radio, NR) developed after LTE-A may be included in systems to which the present disclosure may be applied, and the 5G below may also be a concept that includes the legacy LTE, LTE-A, and other similar services. The present disclosure may be applied to other communication systems through certain modifications, as determined by those skilled in the art, without significantly departing from the scope of the present disclosure. In this case, it will be appreciated that each block of a processing flowchart and combinations of the flowcharts may be executed by computer program instructions.

Since these computer program instructions may be mounted in a processor of a general-purpose computer, a special-purpose computer, or other programmable data processing apparatuses, these computer program instructions executed through the processor of the computer or other programmable data processing apparatuses create means performing functions described in a block(s) of the flowchart. Since these computer program instructions may also be stored in a computer-usable or computer-readable memory that may direct a computer or other programmable data processing apparatus to implement functions in a specific scheme, the instructions stored in the computer-usable or computer-readable memory can produce an article of manufacture including instruction means that perform the functions described in the flowchart block(s). Since the computer program instructions may also be mounted on the computer or other programmable data processing apparatuses, the instructions performing a series of operation steps on the computer or other programmable data processing apparatuses to create processes executed by the computer, thereby executing the computer or other programmable data processing apparatuses may also provide steps for performing the functions described in the block(s) of the flowchart.

Each block may represent some of modules, segments, or codes including one or more executable instructions for executing a specific logical function(s). It is to be noted that functions mentioned in the blocks may occur regardless of order in some various embodiments. For example, two blocks that are continuously illustrated may be simultaneously performed in fact or be sometimes performed in a reverse sequence depending on corresponding functions. In this case, the term ‘~unit’ used in the present embodiment may refer, for example, to software or hardware components such as field programmable gate array (FPGA) or application specific integrated circuit (ASIC), and the ‘~unit’ may perform certain roles. However, the ‘~unit’ is not intended to be limited to the software or hardware. The ‘~unit’ may be configured to be stored in a storage medium that can be addressed or may be configured to reproduce one or more processors. Accordingly, as an example, the ‘~unit’ includes components such as software components, object-oriented software components, class components, and task components, processes, functions, attributes, procedures, subroutines, segments of program code, drivers, firmware, microcode, circuits, data, databases, data structures, tables, arrays and variables. Components and functions provided within ‘~unit’ may be combined into a smaller number of components and ‘~unit’ or may be further separated into additional components and ‘~unit’. Components and ‘~units’ may be implemented to reproduce one or more CPUs in a device or a secure multimedia card. In addition, in an embodiment, the ‘~unit’ may include one or more processors.

Hereinafter, for convenience of explanation, the present disclosure uses terms and names defined in the 5GS and NR specifications, which are standards defined by the 3rd Generation Partnership Project (3GPP) organization among the existing communication standards. However, the present disclosure is not limited to the terms and names, and may be equally applied even to wireless communication networks conforming to other standards. For example, the present disclosure may be applied to the 3GPP 5GS/NR (5G mobile communication standard).

Hereinafter, various example embodiments will be described in greater detail with reference to the accompanying drawings.

Referring to FIG. 2, an electronic device 200 according to an embodiment may include a communication interface (e.g., including circuitry) 230, a processor (e.g., including processing circuitry) 210, and a memory 220. Various embodiments of the present disclosure may be implemented even if some of the illustrated components are omitted or substituted. At least some of each component of the illustrated (or not illustrated) electronic device 200 may be operatively, functionally, and/or electrically connected to each other.

According to an embodiment, the electronic device 200 may include the components and functions of the electronic device 101 of FIG. 1. The electronic device 200 may provide an extended reality (XR) environment that includes augmented reality (AR), which provides additional information over a real environment, virtual reality (VR), which represents a virtual environment, and mixed reality (MR), which is an intermediate form between the AR and the VR.

According to an embodiment, the communication interface 230 may include various circuitry and support communication with various electronic devices over a network. The communication interface 230 may provide various interfaces such as hypertext transfer protocol (HTTP), representational state transfer (REST), message queuing telemetry transport (MQTT), or socket. The server device 200 may communicate, via the communication interface 230, with clients (e.g., a primary device 300 and a secondary device 400 of FIG. 2) on a network, and/or servers (e.g., an RCS AS 500 and a push server 560 of FIG. 2).

According to an embodiment, the memory 220 may store various data temporarily or non-temporarily. The memory 220 may include various types of memory 220, such as random access memory (RAM), virtual memory, cache memory, and/or flash memory.

According to an embodiment, the processor 210 may include variou processing circuitry capable of performing operations or data processing regarding the control and/or communication of each component of the server device 200, and may be implemented as one or more processors. Although there is no limitation on the operations and data processing functions that the processor 210 may implement on the server device 200, various embodiments providing an extended reality (XR) environment will be described below. The operations of the processor 210 to be described below may be performed by loading instructions stored in the memory 220. The detailed description above regarding the processor 120 may be applied equally to the processor 210 here, and as such a detailed description may not be repeated here.

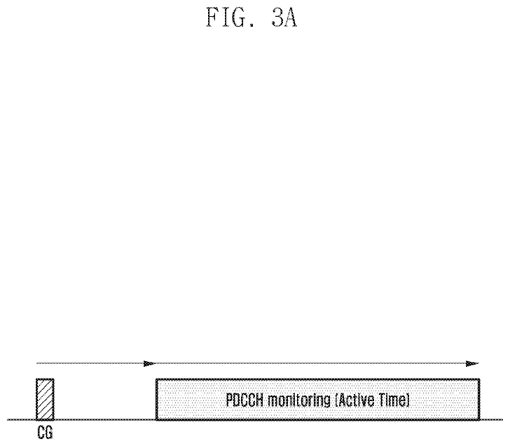

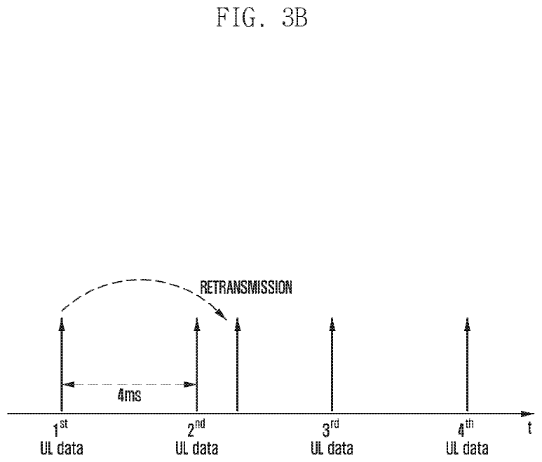

FIG. 3A is a diagram illustrating a situation in which physical downlink control channel (PDCCH) monitoring is performed in a configured grant (CG)-based resource allocation situation according to comparative example.

According to an embodiment, configured grant (CG)-based resource allocation may refer to a scheme in which a base station (e.g., gNB) allocates resources to an electronic device (e.g., terminal, UE) for a predetermined period or continuously. The electronic device may transmit data via the configured resource allocation. The configured grant (CG)-based resource allocation may be utilized for communications with low-latency requirements, such as ultra reliable low latency communication (URLLC).

According to an embodiment, the 3GPP defines an XR traffic model that can be generated in a 5G network as follows. From a downlink perspective, a periodic traffic pattern in which an inter-arrival rate is determined according to a frame rate of an XR video based on a single-stream DL traffic model may be considered. It may be assumed that a packet size follows a probability distribution. For example, XR services with a frame rate of 60 fps may have an inter-arrival rate with a reference interval of 16.6667 ms, and XR services with a frame rate of 120 fps may have an inter-arrival rate with an interval of 8.3333 ms. From an uplink perspective, considering a general UL pose/control traffic model, a pose/control traffic pattern with a periodicity of 4 ms may occur for control based on user motion.

According to an embodiment, to effectively support XR services having traffic patterns in a 5G mobile communication network, it has been designed with the following characteristics for downlink and uplink in 3GPP. For the downlink, it may be designed to have a non-integer-based XR traffic periodicity so that the existing CDRX having a periodicity in integer units may operate in accordance with an XR traffic periodicity. Considering the XR traffic with the frame rate of 60 fps or 120 fps, an interval per frame when DL traffic occurs may be 16.6667 ms or 8.3333 ms. In this case, it may be difficult to express the corresponding interval per frame in the form of an integer multiple. With a DRX configuration, it may be difficult to satisfy the inter-arrival rate of XR DL traffic, which is difficult to express in integer units. To save power on an electronic device (e.g., XR terminal), enhanced CDRX may be performed so that the DRX operation may be performed in accordance with a DL traffic periodicity.

According to an embodiment, Connected Mode DRX(Discontinuous Reception) (CDRX) may refer to a power saving mode for saving energy while a device is not exchanging data. In the CDRX mode, the electronic device (e.g., a terminal) communicates with the network according to a specific pattern to exchange necessary information, and may enter a power-saving state during the remaining time.

According to an embodiment, the DRX configuration may refer to an operation that sets when the device will receive data and when the device will enter a power-saving mode. The DRX configuration may vary depending on network conditions, a battery status of a device, and the amount and frequency of data communication.

According to an embodiment, in a wireless communication system, uplink radio resources (uplink grant) transmitted by the electronic device (e.g., a terminal) to the base station may be classified into a dynamic grant (DG) and a configured grant (CG) according to a resource allocation scheme. The DG is a radio resource for which the base station specifies a location of resources via a downlink control information (DCI) message on a physical downlink control channel (PDCCH) physical channel, and refers to a one-time resource. The CG is a radio resource whose period is configured by a base station through a radio resource control (RRC) message and is repeatedly repeated at a predetermined (e.g., specified) period.

According to an embodiment, the CG may be preconfigured so that uplink radio resources are not dynamically allocated according to traffic conditions but have a specific periodicity based on an RRC configuration. Depending on the format, the CG is classified into a type-1 CG, which is activated immediately upon configuration by an RRC message, and a type-2 CG, which is configured by the RRC message and then uses a configured scheduling—radio network temporary identity (CS-RNTI) to configure and activate a location of a first resource via a DCI message on the PDCCH physical channel. The configured scheduling radio network temporary identifier (CS-RNTI) may refer to a temporary identifier for identifying an electronic device within a specific cell. According to an embodiment, the electronic device (e.g., a terminal) may transmit data to the base station using the Type-1 CG resource after the CG configuration. According to an embodiment, the electronic device (e.g., a terminal) may transmit data to the base station using the type-2 CG resource after the CG resource configured by the RRC has been activated by the network.

According to an embodiment, when the Type-2 CG is activated, the Type-2 CG may have a format that is repeated periodically based on the first configured resource. Since a first resource indicated upon the activation of the Type-2 CG is an uplink radio resource whose location is indicated on a PDCCH physical channel, the first resource exhibits characteristics of the DG, while also exhibiting characteristics of the CG as it is part of the CG configuration in which subsequent resources are periodically repeated.

According to an embodiment, the use of the CG resource for transmission may refer, for example, to the terminal transmitting data called a medium access control protocol data unit (MAC PDU), a transmission block, or a transport block (TB) to the base station using the radio resource. When transmitting a MAC PDU to the base station using the CG resource in this way, the MAC layer of the terminal may deliver the MAC PDU to be transmitted to a HARQ process and instruct the corresponding HARQ process to trigger a new transmission.

According to an embodiment, since the base station determines whether and when to allocate retransmission resources, the terminal may start monitoring the PDCCH in preparation for retransmission.

FIG. 3B is a diagram illustrating a situation in which the order of data is changed due to a long time required for retransmission in the configured grant (CG)-based resource allocation situation according to a comparative example.

According to an embodiment, the CG configuration, excluding information such as the location of the resources configured upon the activation of the CG, may be included in the CG-Config of an RRC message and transmitted by the base station to the terminal. When data to be transmitted via the configured CG resource has short transmission time requirements, such as motion control, high-speed multimedia, extended reality (XR), or ultra-reliable and low-latency communications (URLLC), performing retransmission after transmission in the CG may not satisfy the transmission time requirements. In this case, the base station may not allocate retransmission resources so that the terminal does not perform retransmission after CG transmission.

According to an embodiment, in the CG scheme being considered in the uplink for the XR services, the HARQ operation is applied to each CG transmission. The hybrid automatic repeat request (HARQ) refers to a scheme for resolving errors that occur during data delivery. The HARQ is a technology that combines automatic repeat request (ARQ) and forward error correction (FEC), and may first attempt to correct errors using the FEC, and request retransmission via the ARQ when the number of errors is too large to be corrected by the FEC. Since errors frequently occur in the wireless environment due to signal attenuation and interference, the HARQ may be used to overcome the errors.

For example, it may be assumed that the packet size follows the probability distribution. For example, XR services with a frame rate of 60 fps may have an inter-arrival rate with a reference interval of 16.6667 ms, and XR services with a frame rate of 120 fps may have an inter-arrival rate with an interval of 8.3333 ms. From the uplink perspective, considering the general UL pose/control traffic model, the pose/control traffic pattern with a periodicity of 4 ms may occur for control based on the user motion.

According to an embodiment, when the electronic device performs UL transmission in a CG resource, the base station may instruct retransmission using the CS-RNTI to transmit HARQ feedback to the terminal on the PDCCH when the corresponding CG transmission needs to be retransmitted. The configured scheduling radio network temporary identifier (CS-RNTI) may refer to a temporary identifier for identifying an electronic device (UE) within a specific cell. The CS-RNTI may be used to efficiently manage the electronic device (UE) in the base station (gNB) and to allocate necessary resources.

Therefore, as illustrated in FIG. 3A, the terminal may perform the operation of monitoring the PDCCH for a predetermined period to receive a retransmission indication that may potentially be transmitted from the base station after the UL transmission via the CG resource. Regardless of whether retransmission actually occurs after the UL transmission, the time during which the terminal remains in an active state without entering a sleep state for a predetermined period may occur. The time during which the terminal remains in the active state without entering a sleep state for a predetermined period may cause an unnecessary increase in current consumption when the XR terminal performs uplink transmission.

However, in FIG. 3B, the time required to transmit the next data is approximately 4 ms, whereas the time required for the terminal to retransmit data in response to the retransmission indication may be relatively longer than 4 ms. For example, the electronic device performing the XR may have difficulty performing retransmission because a data transmsission periodicity is shorter than the time required to retransmit data in response to the retransmission indication. In situations where retransmission of data transmitted to the base station is not expected, the electronic device may not need to monitor the PDCCH to receive the retransmission indication that may potentially be transmitted from the base station.

According to an embodiment, the electronic device performing the XR may perform enhanced CDRX to save power. The enhanced CDRX may refer to a scheme in which optimization is performed by aligning a CDRX on duration interval with burst timing in consideration of DL patterns of the XR traffic. However, it may be difficult to consider UL traffic of the XR services during the optimization process. In addition, there is a possibility that the UL transmission may occur during a CDRX off duration.

According to an embodiment, from the UL perspective, it may be necessary to minimize and/or reduce current consumption caused by the increase in active time that may occur at the terminal due to the PDCCH monitoring for HARQ in the UL transmission and CG transmission. Therefore, for the optimization of the CDRX of the electronic device performing the XR, it may be necessary to minimize and/or reduce the on duration interval that may additionally occur due to the UL in the CDRX configuration tailored to the DL.

According to an embodiment, to improve the current consumption from the perspective of the uplink of the electronic device performing the XR, a data block that may be processed without requiring retransmission for the uplink transmission may be required. Retransmission-less UL transmission may refer to data that may be processed without requiring retransmission for the uplink transmission. When retransmission is required by the base station for the UL transmission of the electronic device performing the XR, the electronic device performing the XR may perform the PDCCH monitoring to receive a CS-RNTI DCI indicating the retransmission.

However, as illustrated in FIG. 3B, the retransmission operation may not be suitable for the traffic transmitted via the uplink from the electronic device performing the XR, when considering the transmission periodicity and traffic characteristics. For example, in the UL pose/control traffic, in-sequence delivery between packets may be important, but due to the traffic characteristics, the occurrence periodicity is very short. Therefore, when retransmission occurs, the order of delivered packets may be reversed as illustrated in FIG. 3B. Accordingly, for the uplink transmission of the electronic device performing the XR, a transmission scenario that does not perform retransmission for the CG transmission without the HARQ feedback may be required.

The electronic device according to the present disclosure may provide the method for transmitting data without retransmission in the CG scheme resource allocation structure due to the absence of the HARQ feedback, and the framework for performing the same. The electronic device according to the present disclosure may reduce the power consumption of the electronic device by optimizing the sleep operation interval from the perspective of the UL transmission of the XR services.

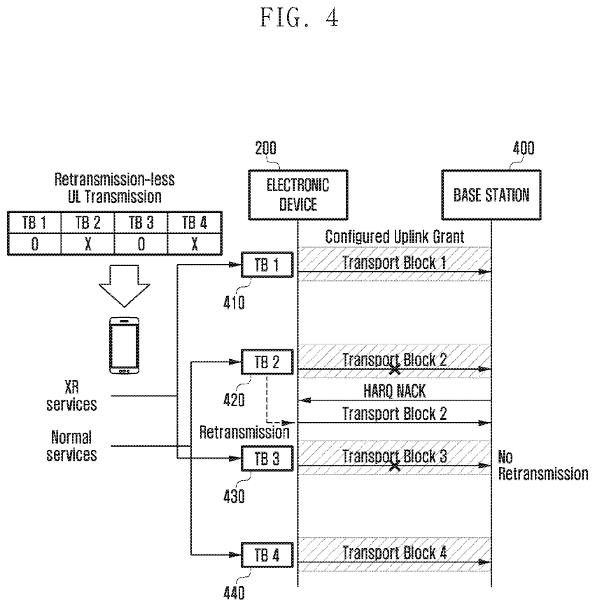

FIG. 4 is a signal flow diagram illustrating a situation in which the electronic device provides the extended reality (XR) services according to various example embodiments.

Referring to FIG. 4, the electronic device 200 may transmit data to a base station 400 using a plurality of data blocks (e.g., a first data block TB1 410, a second data block TB2 420, a third data block TB3 430, and a fourth data block TB4 440).

According to an embodiment, the electronic device 200 may determine, based on identification information, that the first data block TB1 410 and the third data block TB3 430 do not require retransmission or do not perform retransmission. The electronic device 200 may determine that the first data block TB1 410 and the third data block TB3 430 are data blocks that do not perform retransmission. The electronic device 200 may transmit data related to XR using the first data block TB1 410 and the third data block TB3 430, which are determined not to require retransmission. The electronic device 200 may transmit the data related to the XR using the first data block TB1 410 and immediately switch into a sleep state since no retransmission is expected. The electronic device 200 may attempt to transmit the data related to the XR using the third data block TB3 430 and immediately switch into the sleep state since no retransmission is expected. The electronic device 200 may maintain the sleep state without performing retransmission even in situations where the retransmission may be required since the transmission of the third data block TB3 430 is not performed. In this case, even if the retransmission is performed, the transmission periodicity of the data related to the XR is shorter than the retransmission periodicity, so the order of the data may be mixed. This has already been described with reference to FIG. 3B and thus the detailed description may not be repeated here.

On the other hand, the electronic device 200 may determine, based on the identification information, that the second data block TB2 420 and the fourth data block TB4 440 may require retransmission. A data block that may require retransmission may refer to a data block for which the electronic device 200 is required to wait to receive the HARQ feedback, since retransmission may be performed or may not be performed.

The electronic device 200 may use the second data block TB2 420 and the fourth data block TB4 440 to transmit other data unrelated to XR. In this case, since the electronic device 200 may retransmit a data block after transmitting the data block, the electronic device 200 may perform the PDCCH monitoring and remain in an active state.

According to an embodiment, the electronic device 200 may include, in a physical layer (PHY), a framework for controlling whether uplink HARQ feedback is on or off. The electronic device 200 may perform XR separated multiplexing and TB assembly for the retransmission-less UL transmission in the MAC of the corresponding framework.

According to an embodiment, the electronic device 200 may perform separated multiplexing at the MAC layer so that logical channels matching the XR services may be processed on a TB basis or on a TB group basis separate from general services. The media access control (MAC) layer may refer to a layer that manages data transmission in a wireless network. The MAC may perform the roles of data frame generation, addressing, and error detection. In the XR field, the MAC layer may be used to effectively transmit large amounts of data in real time.

According to an embodiment, the electronic device 200 may transmit the MAC PDU to the base station 400 using TBs capable of transmitting data without retransmission. The electronic device 200 may control the UL traffic generated in the XR services to be delivered to the base station 400 without retransmission.

According to an embodiment, the electronic device 200 may identify the XR services that require data transmission without retransmission and traffic generated for the corresponding services. The electronic device 200 may perform multiplexing to control the identified traffic such that the identified traffic is transmitted in a data block (e.g., TB) that does not require retransmission. The electronic device 200 may transmit a data block that does not require retransmission and maintain a sleep state without monitoring the PDCCH for receiving the HARQ feedback to save power consumption.

According to an embodiment, the electronic device 200 may use a MAC entity to determine whether the logical channel configured based on the CG configuration is related to the XR traffic. The electronic device 200 may confirm quality of service (QoS) information of a bearer or flow associated with a specific channel based on RRC configuration information. The electronic device 200 may identify whether a channel is a channel related to the XR traffic based on the quality of service (QoS) information. In addition, the electronic device 200 may confirm a channel matching the XR traffic by confirming whether the CG configuration corresponding to the XR traffic is allocated.

According to an embodiment, the electronic device 200 may perform multiplexing by selectively merging only the traffic existing in buffers of channels that match the XR traffic during the multiplexing and TB assembly process. The electronic device 200 may be configured to include only the multiplexed data in the data block (transport block (TB)) that is agreed not to perform retransmission between the electronic device 200 and the base station 400.

According to an embodiment, the electronic device 200 may transmit the data block and remain in a sleep state until the next wake-up time of the terminal without the PDCCH monitoring operation for receiving the HARQ feedback. Hereinafter, a process in which the electronic device (200) generates identification information for identifying a data block that is agreed not to perform retransmission will be described. In addition, the process of the electronic device 200 identifying the data block using the identification information will also be described in greater detail below.

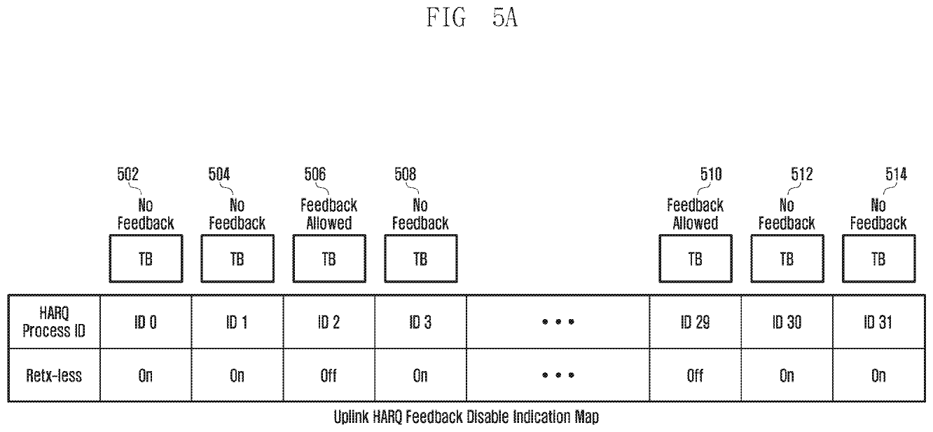

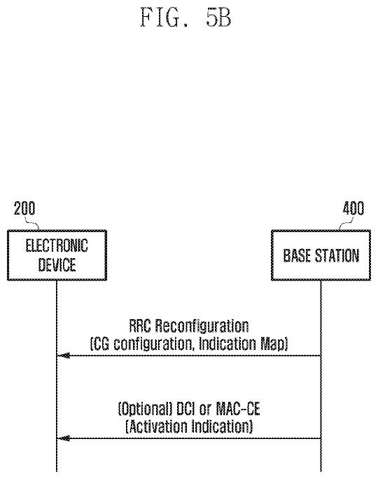

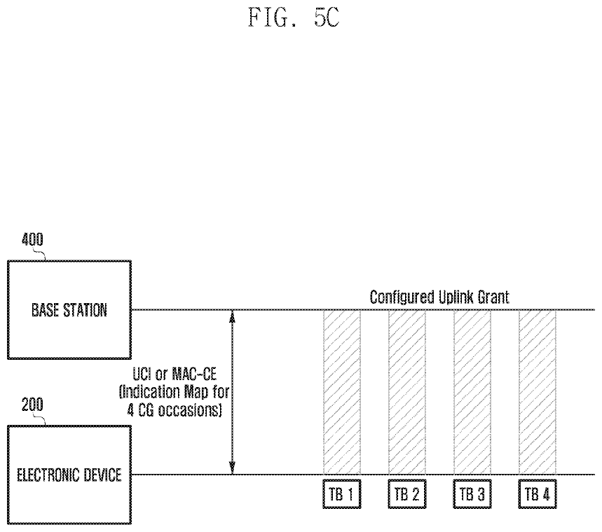

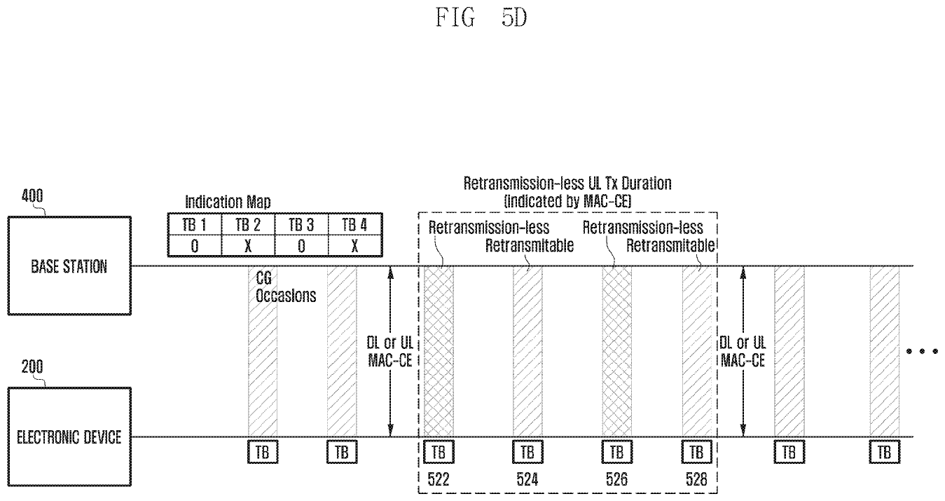

FIG. 5A is a diagram illustrating an example process of generating identification information in which whether HARQ can be retransmitted for each process ID is written according to various example embodiments.

According to an embodiment, the electronic device (e.g., the electronic device 200 of FIG. 2) may have difficulty in operating only specific uplink traffic separately without retransmission (retransmission-less) in a HARQ structure. The hybrid automatic repeat request (HARQ) may refer to a scheme for resolving errors that occur during data delivery. In the HARQ structure, since the electronic device 200 is configured with a common configuration on a cell basis, the electronic device 200 may follow the same HARQ policy at the physical layer even if each traffic is separately processed on a bearer basis, a flow basis, or a logical channel basis.

Therefore, when the electronic device 200 configures a data block (e.g., transport block (TB)) at the MAC layer, data from multiple channels may be included in and assembled into a single data block depending on the status of the remaining buffer of each channel. The transport block (TB) may refer to a block whose size is calculated at the physical layer (PHY).

According to an embodiment, the electronic device 200 may configure, based on the identification information, whether the HARQ feedback is performed on a TB basis or on a TB group basis. According to an embodiment, the electronic device 200 may generate identification information in which whether HARQ can be retransmitted for each process ID is written to indicate whether the HARQ feedback is performed for each data block or each group of data blocks. The identification information may include, for example, an indication map including flags that define whether the HARQ feedback is possible. According to an embodiment, the electronic device 200 may identify a TB for which retransmission is not required based on the configured indication map.

A flag may refer to a signal or indication used to control data transmission. The flag may be used to indicate a specific state or condition with a value of 0 or 1. The electronic device 200 may use a flag to notify the base station of at least one of the start and end of a data packet, an error state, or whether a specific function is enabled. For example, the electronic device 200 may use a flag in a TCP/IP protocol to indicate a packet state and perform data transmission control.

According to an embodiment, the electronic device 200 may select data blocks that do not require data retransmission or do not perform data retransmission based on the identification information. The electronic device 200 may identify data blocks that will not perform retransmission, and when the electronic device 200 receives a data block (e.g., TB) identified by the corresponding HARQ process ID, the electronic device 200 may not transmit the HARQ feedback for retransmission to the data included in the corresponding data block.

Referring to FIG. 5A, the identification information may be configured in a format in which whether the data retransmission is required for each HARQ process ID is written. The data block may match the HARQ process ID. For example, a first data block (TB) 502 may correspond to ID 0. The first data block (TB) 502 may be a data block that does not perform retransmission. The electronic device 200 may indicate that whether retransmission is not required for the first data block 502 corresponding to ID 0 is ‘on’. The electronic device 200 may transmit the first data block 502 indicated as ‘on’ for whether retransmission is not required, terminate monitoring of the PDCCH for retransmission, and maintain a sleep state.

Referring to FIG. 5A, the electronic device 200 may indicate that whether retransmission is not required for a second data block TB 504 corresponding to ID 1 is ‘on’. The electronic device 200 may transmit the second data block 504 indicated as ‘on’ for whether retransmission is not required, terminate monitoring of the PDCCH for retransmission, and maintain a sleep state.

According to an embodiment, the electronic device 200 may indicate that whether retransmission is not required for a third data block TB 506 corresponding to ID 2 is ‘off’. The electronic device 200 may transmit the third data block 506 indicated as ‘off’ for whether retransmission is not required, and maintain a wake up state while monitoring the PDCCH for retransmission.

According to FIG. 5A, the electronic device 200 may indicate that whether retransmission is not required for a fourth data block (TB) 508 corresponding to ID 3, a sixth data block 512 corresponding to ID 30, and a seventh data block 514 corresponding to ID 31 is ‘on’. The electronic device 200 may transmit at least one data block indicated as ‘on’ for whether retransmission is not required, terminate monitoring of the PDCCH for retransmission, and maintain a sleep state.

Referring to FIG. 5A, the electronic device 200 may indicate that whether retransmission is not required for a fifth data block TB 510 corresponding to ID 29 is ‘off’. The electronic device 200 may transmit the fifth data block 510 indicated as ‘off’ for whether retransmission is not required, and maintain a wake up state while monitoring the PDCCH for retransmission. The number of data blocks, the type of HARQ process ID, and whether retransmission is not required are merely examples and are not limited to the examples described in FIG. 5A.

For example, the electronic device 200 may receive a bitmap structure from the base station 400. The electronic device 200 may determine the type of HARQ process ID and whether retransmission is not required based on a bitmap received from a base station or network.

FIG. 5B is a signal flow diagram illustrating an example base station-based identification information management scheme according to various example embodiments.

According to an embodiment, the electronic device 200 may identify data blocks that are configured not to be retransmitted using identification information. The identification information may be classified into multiple types according to the managing entity and the deliver scheme.

Referring to FIG. 5B, the base station 400 may generate identification information for the CG configuration and for uplink HARQ to be used during a corresponding transmission, for a terminal via a RRC configuration. The radio resource control (RRC) configuration may refer to a process for controlling and managing radio resources in a mobile communication network.

Base station-based operation embodiments may be applied to the uplink with a scheme similar to downlinkHARQ-FeedbackDisabled-r17 related to downlink HARQ feedback (e.g., for disabling feedback) in, for example, Rel-17 NTN. The electronic device 200 may receive a bitmap structure from the base station 400. The electronic device 200 may determine the type of HARQ process ID and whether retransmission is not required based on the bitmap configured in the base station 400 or network. downlinkHARQ-FeedbackDisabled-r17 is part of the 3 5G new radio (NR) standard and may refer, for example, to a state in which hybrid automatic repeat reQuest (HARQ) feedback is disabled. The HARQ may refer to a protocol for retransmitting a data packet if an error occurs when the packet is transmitted from the sender to the receiver. In the protocol, the receiver may transmit feedback regarding the received packet to the sender. The feedback may include whether the packet was successfully received (acknowledgement (ACK)) or whether retransmission is required (not acknowledgement (NACK)). When the downlinkHARQ-FeedbackDisabled-r17 configuration is enabled, this feedback process may be disabled. In this case, the electronic device 200 may determine not to perform retransmission uniformly even when retransmission is required, and may change the state of the electronic device 200 to a sleep state.

In FIG. 5B, the electronic device 200 may identify a data block (e.g., TB) for which retransmission is not required based on identification information (e.g., indication map) configured by the base station 400 via the RRC. The electronic device 200 may configure whether to enable the identification information from the base station 400 via DCI or media access control (MAC)-control element (CE). The media access control (MAC)-control element (CE) is part of a MAC protocol data unit (PDU) and may be used to deliver control information over a wireless link. The MAC-CE may include a buffer status report (BSR). The electronic device 200 may transmit its own buffer status to the base station 400 using the BSR. The downlink control information (DCI) may refer to control information used at a physical layer. The DCI may be used by the base station 400 to deliver downlink or uplink scheduling information to the electronic device 200. The downlink or uplink scheduling information may refer to information that instructs the electronic device 200 when and on which resource block to receive or transmit data. The DCI may be transmitted via a physical downlink control channel (PDCCH).

According to an embodiment, the base station 400 may determine whether to enable identification information regarding whether the uplink HARQ feedback is on or off. The base station 400 may determine whether to enable the identification information and instruct the electronic device 200 to control whether to perform retransmission. Based on the identification information being enabled, the electronic device 200 may identify a data block (e.g., a TB) for which retransmission is not required and transmit the data related to the XR.

FIGS. 5C and 5D are diagrams illustrating an example electronic device-based identification information management scheme according to various example embodiments.

Referring to FIG. 5C, the electronic device 200 may generate identification information and, based on the identification information, determine whether to retransmit a certain number of data blocks to be transmitted. The electronic device 200 may transmit to the base station 400 whether to retransmit a certain number of data blocks using uplink control information (UCI) or MAC-CE. The electronic device 200 may transmit control information to the base station 400 using the uplink control information (UCI). The base station 400 may determine whether to perform retransmission for the transmitted data blocks based on the identification information received from the electronic device 200. When the retransmission is required, the base station 400 may transmit HARQ retransmission feedback to the electronic device 200. On the other hand, when retransmission is not required, the base station 400 may not transmit the HARQ retransmission feedback to the electronic device 200. When the electronic device 200 transmits data blocks determined not to require retransmission, the electronic device 200 may determine that the HARQ retransmission feedback will not be received and may not perform the PDCCH monitoring. After transmitting a data block determined not to require retransmission, the electronic device 200 may switch its state into a sleep state. The electronic device 200 may reduce power consumption by switching into a sleep state. In addition, the electronic device 200 may prevent and/or reduce power waste consumed for PDCCH monitoring while waiting for retransmission feedback.

Referring to FIG. 5D, the electronic device 200 may not receive uplink HARQ feedback for a certain interval.

According to an embodiment, the base station 400 may transmit identification information regarding the CG configuration and the uplink HARQ to the electronic device 200 via the RRC configuration. The electronic device 200 may determine an on-off of whether to perform the uplink HARQ feedback based on the identification information. The electronic device 200 may enable or disable whether feedback is performed by transmitting information regarding the feedback activation to the base station 400 via the MAC-CE.

According to an embodiment, the electronic device 200 may determine whether to perform the HARQ feedback according to a semi-persistent scheme. The semi-persistent scheme may refer to a scheme in which the HARQ feedback is not performed for all data blocks (e.g., 522, 524, 526, and 528) located within a certain interval (e.g., an interval where the uplink HARQ feedback is disabled).

According to an embodiment, the base station 400 may determine whether data can be retransmitted based on data transmission-related performance (e.g., capability, data transmission periodicity) of the electronic device 200 when the electronic device 200 is connected to a cell. The base station 400 may configure the identification information (e.g., indication map) when the electronic device 200 supports transmission for a data block that does not require retransmission. The identification information may include information regarding whether the uplink HARQ feedback is performed.

According to an embodiment, the base station 400 may transmit the MAC-CE to the electronic device 200 at the time it determines that uplink HARQ operation is not required. The base station 400 may indicate activation regarding whether the HARQ feedback configured via the RRC is performed. Based on the activation indication regarding whether the HARQ feedback is performed, the electronic device 200 may identify a data block for which a HARQ feedback operation is not performed based on the identification information. The electronic device 200 may multiplex and assemble the data related to the XR that does not require retransmission into the identified data block and transmit the multiplexed and assembled data to the base station 400.

According to an embodiment, the base station 400 may identify a data block for which the HARQ operation is not performed based on the identification information after receiving the MAC-CE. The base station 400 may not perform the HARQ operation on the identified data block and may not transmit the HARQ feedback for retransmission even if the reception of the data block fails.

The operation of identifying the data block based on the identification information may not be limited to a case in which the base station 400 or the electronic device 200 performs the operation independently. For example, the base station 400 and the electronic device 200 may perform the operation of identifying the data block based on the identification information together. For example, the electronic device 200 may not perform the HARQ feedback for all data blocks (e.g., 522, 524, 526, and 528) located within a certain interval (e.g., an interval where the uplink HARQ feedback is disabled). The electronic device 200 may identify, based on the identification information, a data block that does not require retransmission among the data blocks (e.g., 522, 524, 526, and 528) located within a certain interval. The certain interval may vary depending on the configuration.

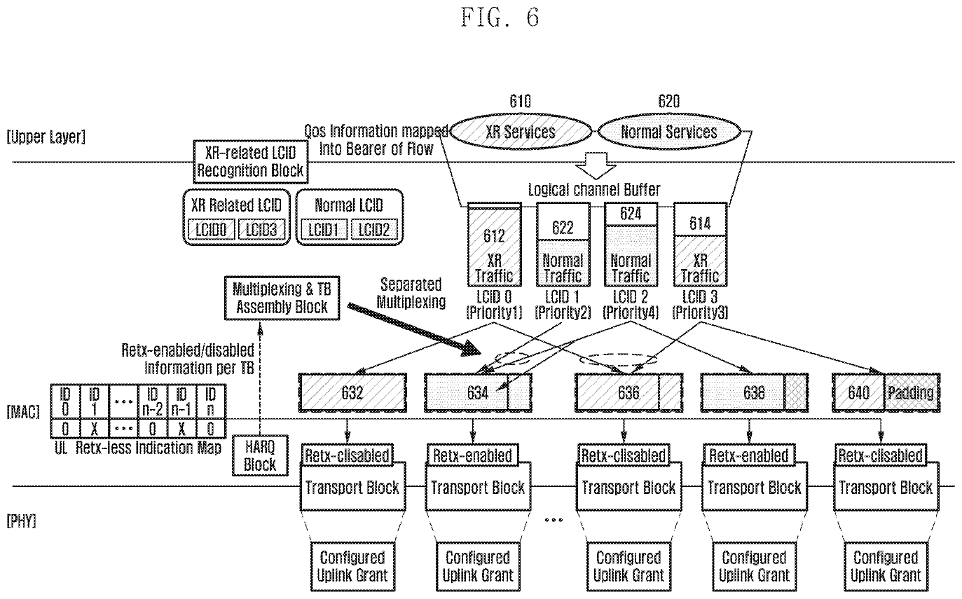

FIG. 6 is a diagram illustrating an example process in which an electronic device distinguishes a data block that does not require retransmission and performs multiplexing and assembling of XR data according to various example embodiments.

Referring to FIG. 6, the electronic device (e.g., the electronic device 200 of FIG. 2) may classify data to be transmitted to a base station (e.g., the base station 400 of FIG. 4) into two groups. The electronic device 200 may be classified into first data 610 related to the extended reality (XR) and second data 620 unrelated to the extended reality (XR).

According to an embodiment, the first data 610 related to the extended reality (XR) and the second data 620 unrelated to the extended reality (XR) may be distinguished into logical channels by a logical channel ID (LCID). A logical channel may refer to a path for transmitting a specific type of data. Each logical channel may have a unique LCID. The logical channel ID (LCID) may refer to an identifier used in the MAC layer of wireless communication. The LCID may be used to distinguish a specific logical channel. The MAC layer may manage various logical channels using the LCID and select an appropriate channel to transmit various types of data.

In FIG. 6, the first data 610 related to the extended reality (XR) may be included in logical channels corresponding to LCID 0 612 and LCID 3 614. The second data 620 unrelated to the extended reality (XR) may be included in logical channels corresponding to LCID 1 622 and LCID 2 624. Data included in the logical channels corresponding to the LCID 0 612 and the LCID 3 614 may be included in data blocks and transmitted to a base station 400. The electronic device 200 may multiplex and assemble data included in the logical channels corresponding to the LCID 0 612 and the LCID 3 614 into the selected data block. The electronic device 200 may identify the data block (e.g., TB) that is configured as not requiring data retransmission based on the identification information.

For example, the electronic device 200 may determine, based on the identification information, that a first block 632, a third block 636, and a fifth block 640 are blocks for which retransmission is not required. The electronic device 200 may preferentially include the data related to the XR included in the LCID 0 612 in the first block 632 and the third block 636. When there is remaining space in the third block 636, the electronic device 200 may confirm whether there is remaining data in another buffer. The remaining data may refer to the first data 610 related to the extended reality (XR). When only the second data 620 unrelated to the extended reality (XR) remains in the buffer, the electronic device 200 may maintain the remaining space in the third block 636 in an empty state and transmit the data block. In FIG. 6, since the data related to the XR remains in the LCID 3 614, the electronic device 200 may fill the third block 636 with the data included in the LCID 3 614. Subsequently, when there is data remaining in the LCID 3 614, the electronic device 200 may fill the fifth block 640 with data. When there is remaining space in the fifth block 640, the electronic device 200 may confirm whether there is remaining data in another buffer. The remaining data may refer to the first data 610 related to the extended reality (XR). When only the second data 620 unrelated to the extended reality (XR) remains in the buffer, the electronic device 200 may maintain the remaining space in the fifth block 640 in an empty (or padded) state and transmit the data block.

According to an embodiment, padding in data communication may refer to bits or bytes that are inserted to meet specific length requirements. Padding is typically added to the end of the data block or packet and may be used to meet specific length requirements, align data, or enhance security. When transmitting data at the MAC layer, the padding may be added when the size of the data is not a multiple of a specific size. When the size of the MAC frame is required to be a multiple of a fixed size (e.g., a multiple of 8 bytes), if the actual data size falls short of this requirement, the padding may be used to fill the remaining portion. In FIG. 6, the electronic device 200 may use the padding to fill the size of the data block or frame when there is no data or insufficient data. The electronic device 200 may transmit a data block while maintaining the remaining space of the fifth block 640 in an empty (or padded) state in a situation where the first data 610 related to the extended reality (XR) remains absent.

Referring to FIG. 6, the electronic device 200 may determine, based on the identification information, that the second block 634 and the fourth block 638 are blocks for which retransmission may require. The electronic device 200 may preferentially include the data related to the XR included in the LCID 1 622 in the second block 634. When there is remaining space in the second block 634, the electronic device 200 may confirm whether there is remaining data in another buffer. Here, the remaining data may refer to the second data 620 unrelated to the extended reality (XR). When only the first data 610 related to the extended reality (XR) remains in the buffer, the electronic device 200 may maintain the remaining space in the second block 634 in an empty state and transmit the data block.

In FIG. 6, the electronic device 200 may fill the remaining space of the second block 634 with data because the second data 620 unrelated to the extended reality (XR) remains in the LCID 2 624. When there is insufficient space to fill the second block 634 with data, the electronic device 200 may fill the fourth block 638 with the remaining data. When there is remaining space in the fourth block 638, the electronic device 200 may confirm whether there is remaining data in another buffer. When only the first data 610 related to the extended reality (XR) remains in the buffer, the electronic device 200 may maintain a remaining space of a fourth block 638 in the empty state or the padding state and transmit the data block. The electronic device 200 may classify data into the first data 610 related to the extended reality (XR) and the second data 620 unrelated to the extended reality (XR), and transmit the classified data. In this case, the electronic device 200 may be configured so that the first data 610 related to the extended reality (XR) is included only in data blocks determined not to require retransmission. Using the data blocks determined not to require retransmission, the electronic device 200 may prevent and/or reduce power consumption of the electronic device 200 and manage data more efficiently. Conversely, the electronic device 200 may transmit data by including the second data 620 unrelated to the extended reality (XR) in the data blocks determined to potentially require retransmission. In this case, the electronic device 200 may perform the HARQ feedback and perform retransmission when retransmission is required, and may control the data to be reliably transmitted to the base station 400.

According to an embodiment, the electronic device 200 may configure whether to enable the identification information from the base station 400 via the DCI or the MAC-CE. The media access control (MAC)-control element (CE) is part of a MAC protocol data unit (PDU) and may be used to deliver control information over a wireless link.

According to an embodiment, the electronic device 200 may identify a channel associated with XR traffic among logical channels in an XR-related LCID identification block within a MAC entity. The XR-related LCID identification block may determine whether a plurality of channels configured in the MAC are channels including the data related to the XR. The data related to the XR may include data for which retransmission is not required.

According to an embodiment, the XR-related LCID identification block may receive information related to a bearer or flow mapped to a channel from an upper layer. Based on the received information, the XR-related LCID identification block may determine whether each channel includes the data related to the XR. The upper layer may include a packet data convergence protocol (PDCP) layer or a service data adaptation protocol (SDAP) layer. The packet data convergence protocol (PDCP) layer may perform compression, encryption, and error detection of a data packet. The service data adaptation protocol (SDAP) layer may manage a quality of service (QoS). The SDAP layer may map data received from other layers to a specific QoS flow and connect the data to a logical channel, thereby ensuring data transmission that satisfies a specific QoS requirement.

According to an embodiment, the electronic device 200 may consider channel-specific priorities. The electronic device 200 may preferentially retrieve data from a high-priority channel and include the data in a data block. When all data included in the XR-related channel with the high priority is exhausted, the electronic device 200 may include data included in a channel with the next highest priority in the data block. When a space remains in the data block but data included in the XR-related channel does not remain, the electronic device 200 may pad the remaining space instead of filling the remaining space with data from another channel.

According to an embodiment, padding in data communication may refer to bits or bytes that are inserted to meet specific length requirements. Padding is typically added to the end of the data block or packet and may be used to meet specific length requirements, align data, or enhance security. When transmitting data at the MAC layer, the padding may be added when the size of the data is not a multiple of a specific size. When the size of the MAC frame is required to be a multiple of a fixed size (e.g., a multiple of 8 bytes), if the actual data size falls short of this requirement, the padding may be used to fill the remaining portion. In FIG. 6, the electronic device 200 may use the padding to fill the size of the data block or frame when there is no data or insufficient data.

According to an embodiment, the electronic device 200 may allocate only the data 610 related to the XR to be transmitted from a data block determined not to perform retransmission. The electronic device 200 may separate the data related to the XR from general data so that the HARQ retransmission is not performed separately.

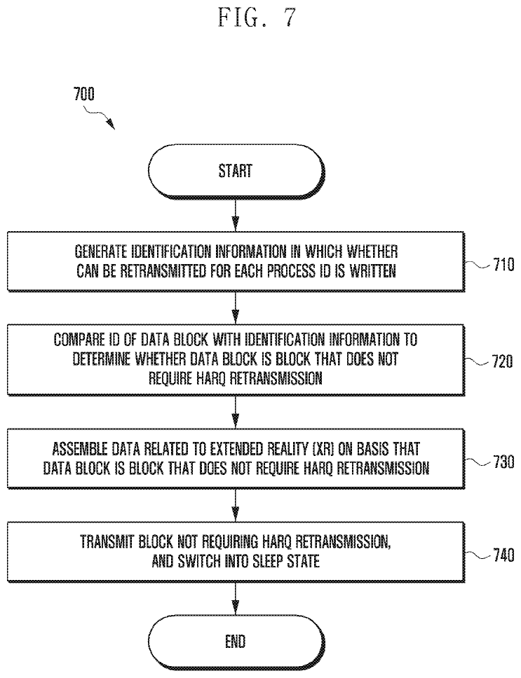

FIG. 7 is a flowchart illustrating an example method for transmitting data by an electronic device according to various example embodiments.

The operations described with reference to FIG. 7 may be implemented based on instructions that may be stored in a computer recording medium or memory (e.g., the memory 130 of FIG. 1). A method 700 illustrated may be executed by the electronic device (e.g., electronic device 200 of FIG. 2) described above with reference to FIGS. 1 to 6, and the technical features described above may not be repeated here. The order of each operation of FIG. 7 may be changed, some operations may be omitted, and some operations may be performed simultaneously.

In operation 710, the electronic device 200 may generate identification information in which whether HARQ can be retransmitted for each process ID is written. The electronic device 200 may receive identification information (e.g., bitmap) from a base station (e.g., the base station 400 of FIG. 4) and transmit data based on the received identification information. For example, the base station 400 may determine whether data can be retransmitted based on data transmission-related performance (e.g., capability, data transmission periodicity) of the electronic device 200 when the electronic device 200 is connected to a cell.

According to an embodiment, the electronic device 200 may match the HARQ process ID in units of data blocks and generate identification information using a flag that indicates whether the HARQ feedback is possible for each HARQ process ID. The identification information may include, for example, an indication map including flags that define whether the HARQ feedback is possible. A flag may refer to a signal or indication used to control data transmission. The flag may be used to indicate a specific state or condition with a value of 0 or 1.

In operation 720, the electronic device 200 may compare an ID of a data block with the identification information to determine whether the data block is a block that does not require HARQ retransmission. According to an embodiment, whenever a data block is generated, the electronic device 200 may compare the ID of the data block with identification information to determine whether the data block is a block that may require the HARQ retransmission.

According to an embodiment, the electronic device 200 may select data blocks that do not require data retransmission or do not perform data retransmission based on the identification information. The electronic device 200 may identify data blocks that will not perform retransmission, and when the electronic device 200 receives a data block (e.g., TB) identified by the corresponding HARQ process ID, the electronic device 200 may not transmit the HARQ feedback for retransmission to the data included in the corresponding data block.

In operation 730, the electronic device 200 may assemble the data related to the extended reality (XR) based on the data block being a block that does not require the HARQ retransmission. The electronic device 200 may assemble the remaining data unrelated to the extended reality (XR) when transmitting a block that may require HARQ retransmission.

In operation 740, the electronic device 200 may transmit the block not requiring HARQ retransmission and switch the electronic device 200 into a sleep state. The electronic device 200 may be controlled to maintain an active state and perform PDCCH monitoring when transmitting a block that may require retransmission.

According to an embodiment, the electronic device 200 may confirm a data block that does not require retransmission based on the identification information. The electronic device (200) may transmit the data block based on confirmation that the data block does not require retransmission, and then may not request retransmission from the base station.

According to an embodiment, the electronic device 200 may receive, from the base station, identification information in which whether HARQ can be retransmitted for each process ID is written. The identification information may be transmitted using the media access control (MAC)-control element (CE) of the MAC layer or the downlink control information (DCI) of the physical layer. The media access control (MAC)-control element (CE) is part of a MAC protocol data unit (PDU) and may be used to deliver control information over a wireless link. The downlink control information (DCI) may refer to control information used at a physical layer. The DCI may be used by the base station 400 to deliver downlink or uplink scheduling information to the electronic device 200. The downlink or uplink scheduling information may refer to information that instructs the electronic device 200 when and on which resource block to receive or transmit data. The DCI may be transmitted via a physical downlink control channel (PDCCH).

According to an embodiment, the electronic device 200 may generate identification information in which whether HARQ can be retransmitted for each process ID is written and transmit a data block to be transmitted to the base station based on the generated identification information. The identification information may be transmitted using the media access control (MAC)-control element (CE) of the MAC layer or the uplink control information (UCI) of the physical layer. The electronic device 200 may transmit to the base station 400 whether to retransmit a certain number of data blocks using uplink control information (UCI) or MAC-CE. The electronic device 200 may transmit control information to the base station 400 using the uplink control information (UCI). The base station 400 may determine whether to perform retransmission for the transmitted data blocks based on the identification information received from the electronic device 200. When the retransmission is required, the base station 400 may transmit HARQ retransmission feedback to the electronic device 200. When retransmission is not required, the base station 400 may not transmit the HARQ retransmission feedback to the electronic device 200.

According to an embodiment, the electronic device 200 may transmit, to the base station, a message indicating that the HARQ retransmission is not required for data blocks transmitted during a specified time, and control the electronic device to switch into a sleep state after transmitting the data block that does not require HARQ retransmission. This has already been described with reference to FIG. 5D and thus a detailed description may not be repeated here.

According to an embodiment, the electronic device 200 may not receive uplink HARQ feedback for a certain interval. For example, the electronic device 200 may not perform the HARQ feedback for all data blocks (e.g., 522, 524, 526, and 528 of FIG. 5D) located within a certain interval (e.g., an interval where the uplink HARQ feedback is disabled). The electronic device 200 may identify, based on the identification information, a data block that does not require retransmission among the data blocks (e.g., 522, 524, 526, and 528) located within a certain interval.

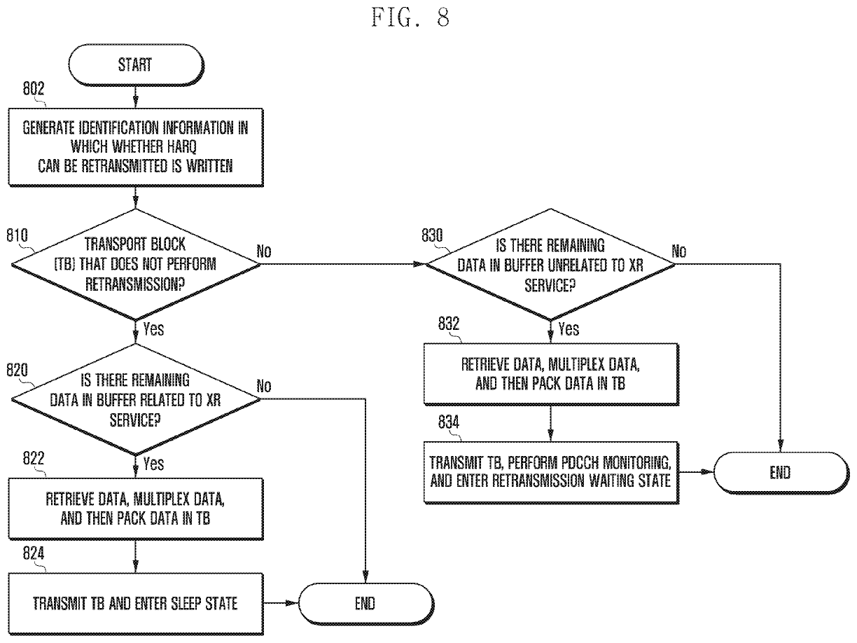

FIG. 8 is a flowchart illustrating an example method for transmitting data by an electronic device according to various example embodiments.

The operations described with reference to FIG. 8 may be implemented based on instructions that may be stored in a computer recording medium or memory (e.g., the memory 130 of FIG. 1). A method illustrated in FIG. 8 may be executed by the electronic device (e.g., electronic device 200 of FIG. 2) described above with reference to FIGS. 1 to 6, and the technical features described above may not be repeated here. The order of each operation of FIG. 8 may be changed, some operations may be omitted, and some operations may be performed simultaneously.

In operation 802, the electronic device 200 may generate identification information in which whether HARQ can be retransmitted is written. Alternatively, the electronic device 200 may receive identification information (e.g., bitmap) from a base station (e.g., the base station 400 of FIG. 4) and transmit data based on the received identification information.

According to an embodiment, the identification information may include pieces of feedback information corresponding to one or more hybrid automatic repeat request (HARQ) process IDs. The hybrid automatic repeat request (HARQ) process ID may refer to an identifier used to request and manage retransmission of a packet in wireless communication. The HARQ is an extension of the concept of automatic repeat request (ARQ), which requests retransmission when an error occurs. The HARQ may include information for retransmission in preparation for the case where an error occurs from the time when the packet is first transmitted. The electronic device 200 may correct errors by combining a new packet with an original packet when a packet needs to be retransmitted due to the errors based on the feedback information regarding the HARQ. The HARQ process ID may refer to an identifier used to manage the retransmission request of the packet in the electronic device 200. Each HARQ process may have a unique ID. The electronic device 200 may determine which packet the wireless communication system needs to retransmit using the pieces of feedback information corresponding to the hybrid automatic repeat request (HARQ) process ID. The electronic device 200 may determine which packet has been successfully transmitted using the pieces of feedback information corresponding to the hybrid automatic repeat request (HARQ) process ID.

In operation 810, the electronic device 200 may determine, based on the identification information, whether a data block is a transport block (TB) for which retransmission is not required. According to an embodiment, the electronic device 200 may identify, under the control of the processor 210, a data block determined not to perform HARQ retransmission (HARQ-less).

In operation 820, the electronic device 200 may determine whether there is data remaining in the buffer related to XR services based on the data block not requiring retransmission.

In operation 822, the electronic device 200 may retrieve remaining data from the buffer related to the XR services, perform multiplexing on the retrieved data, and include the multiplexed data in the data block (e.g., TB). The multiplexing may refer to the operation of transmitting multiple input signals via a single output channel. The electronic device 200 may use the multiplexing to transmit signals from multiple data sources at once. The electronic device 200 may use the multiplexing to improve overall communication efficiency and increase channel utilization. The electronic device 200 may retrieve data from a buffer and perform multiplexing on a data block. The electronic device 200 may collect data from multiple buffers and then pack the collected data into a single data block. The packed data block may be transmitted via a single communication channel.

In operation 824, the electronic device 200 may transmit the data block (e.g., TB) and enter a sleep state.

In operation 820, the electronic device 200 may pad the remaining portion of the data block when it is determined that there is no remaining data in the buffer related to the XR services. The electronic device 200 may transmit the data block and terminate the operation of FIG. 8. The padding in data communication may refer to bits or bytes that are additionally inserted to meet specific length requirements. Padding is typically added to the end of the data block or packet and may be used to meet specific length requirements, align data, or enhance security. When transmitting data at the MAC layer, the padding may be added when the size of the data is not a multiple of a specific size. When the size of the MAC frame is required to be a multiple of a fixed size (e.g., a multiple of 8 bytes), if the actual data size falls short of this requirement, the padding may be used to fill the remaining portion.

In operation 830, the electronic device 200 may confirm whether there is remaining data in the buffer unrelated to the XR services on the basis that the data block may be retransmitted.

In operation 832, the electronic device 200 may retrieve the remaining data from the buffer unrelated to the XR services, perform multiplexing on the retrieved data, and include the multiplexed data in the data block (e.g., TB), based on there being remaining data in the buffer unrelated to the XR services. The multiplexing may refer to the operation of transmitting multiple input signals via a single output channel. The electronic device 200 may use the multiplexing to transmit signals from multiple data sources at once. The electronic device 200 may collect data from multiple buffers and then pack the collected data into a single data block. The packed data block may be transmitted via a single communication channel.

In operation 834, the electronic device 200 may transmit the data block (e.g., TB) and perform the PDCCH monitoring. The electronic device 200 may wait for retransmission while maintaining an active state.

In operation 830, the electronic device 200 may pad the remaining portion of the data block when it is determined that there is no remaining data in the buffer unrelated to the XR services. The electronic device 200 may transmit the data block and terminate the operation of FIG. 8. The padding processing has been described above and may not be repeated here.

According to an embodiment, whenever the data block (e.g., TB) is generated by the CG configuration, the electronic device 200 may confirm whether the generated data block is a data block that does not require retransmission based on the identification information (e.g., indication map). The electronic device 200 may determine differently the data of the data block depending on whether the data block is a data block that does not require retransmission. For example, when the data block does not require retransmission, the electronic device 200 may retrieve data from a buffer of a channel including the data related to the XR. Conversely, when the data block may require retransmission, the electronic device 200 may retrieve data from the buffer of the channel including the data unrelated to the XR services.

According to an embodiment, when there is data to be transmitted in the buffer of the channels related to the XR services, the electronic device 200 may retrieve the data and perform multiplexing on the retrieved data. Subsequently, the electronic device 200 may include the multiplexed data in the data block. The operation of configuring the data block may be performed until no data remains in the buffer of the channels related to the XR services. The electronic device 200 may pad the data block even when there is an empty space in the data block when no data remains in the buffer of the channels related to the XR services. The electronic device 200 may pad the empty space of the data block to control the data related to the XR services not to be mixed with the remaining data.

According to an embodiment, the electronic device 200 may transmit the data block determined not to require retransmission to the base station (e.g., base station 400 of FIG. 4). Since retransmission is not expected in this situation, the electronic device 200 may stop the PDCCH monitoring immediately after transmitting the data block and switch into a sleep state.

The electronic device 200 may transmit the data block determined to require retransmission to the base station 400. The electronic device 200 may perform the PDCCH monitoring to receive the related feedback message, as retransmission may be required depending on the data block reception status of the base station 400. In this case, the electronic device 200 may maintain an active state.

According to an example embodiment, under the control of the processor 210, the electronic device 200 identify, based on pieces of feedback information corresponding to one or more hybrid automatic repeat request (HARQ) process IDs, a first data block determined not to perform HARQ retransmission (HARQ-less) among one or more data blocks.

According to an example embodiment, the identification information for identifying the first data block may include the pieces of feedback information corresponding to one or more hybrid automatic repeat request (HARQ) process IDs. The hybrid automatic repeat request (HARQ) process ID may refer to an identifier used to request and manage retransmission of a packet in wireless communication. The electronic device 200 may determine which packet the wireless communication system needs to retransmit using the pieces of feedback information corresponding to the hybrid automatic repeat request (HARQ) process ID. Alternatively, the electronic device 200 may determine which packet has been successfully transmitted using the pieces of feedback information corresponding to the hybrid automatic repeat request (HARQ) process ID.

According to an example embodiment, when at least one block is identified as the first data block, the electronic device 200 may use the identified first data block to transmit data classified as not being retransmitted to the base station 400. The data classified as not being retransmitted may include, for example, the data related to the extended reality (XR). The extended reality (XR)-related data may refer to traffic generated for services in an XR device. Since the extended reality (XR) environment may require data transmission in real time, the retransmission periodicity may be relatively short compared to other data transmission situations. In this case, even if the electronic device 200 retransmits the data related to the XR (e.g., 1st UL data), as described in FIG. 3B, the transmission of the data related to the XR may be delayed compared to the next-sequence data (e.g., 2nd UL data), so the data sequence may not be satisfied. Therefore, the electronic device 200 may retransmit the data related to the XR.

According to an example embodiment, the electronic device 200 may stop monitoring the physical downlink control channel (PDCCH) being executed for retransmitting the HARQ and switch the electronic device into a sleep state.

According to an example embodiment, the pieces of feedback information corresponding to one or more HARQ process IDs may include the identification information indicating whether to retransmit the HARQ for each HARQ process ID. The identification information may be generated by the electronic device 200 or received via any one of the base station 400 or the network. When the first data block is identified, the electronic device 200 may multiplex and assemble the data related to the extended reality (XR) in the logical channel buffer and transmit the multiplexed and assembled data to any one of the base station or the network via the first data block.

According to an example embodiment, the electronic device 200 may compare the ID of the data block with the identification information whenever the data block is generated to identify whether the data block is a block determined not to perform the HARQ retransmission. The data block that may perform the HARQ retransmission may be referred to as a second data block. The electronic device 200 may identify the second data block, and when the second data block is identified, may multiplex and assemble the remaining data unrelated to extended reality (XR) into the second data block. The electronic device 200 may transmit the multiplexed and assembled data to the base station via the second data block and perform the PDCCH monitoring. The PDCCH monitoring may be performed to prepare for the case where data is retransmitted upon receiving the HARQ feedback.

According to an example embodiment, the electronic device 200 may match the HARQ process ID to each unit of each data block among one or more data blocks and generate the identification information using a flag indicating whether the HARQ feedback is possible for each HARQ process ID. Based on the identification information, the electronic device 200 may confirm whether the data block is determined not to perform retransmission. The electronic device 200 may transmit the first data block based on the confirmation that any one of the blocks is the first data block determined not to perform retransmission, and may not transmit the HARQ feedback for retransmission to the base station. In this case, since the base station will not request data retransmission based on the HARQ feedback, the electronic device 200 may switch into a sleep state as there is no probability of receiving a request for data retransmission.

According to an example embodiment, the electronic device 200 may receive, from the base station via the network, the identification information in which whether HARQ can be retransmitted for each process ID is written. The identification information may be transmitted using the media access control (MAC)-control element (CE) of the MAC layer or the downlink control information (DCI) of the physical layer.

According to an example embodiment, the electronic device 200 may generate identification information in which whether HARQ can be retransmitted for each process ID is written and transmit a data block to be transmitted to the base station based on the generated identification information. The identification information may be transmitted to the base station using the media access control (MAC)-control element (CE) of the MAC layer or the uplink control information (UCI) of the physical layer.

According to an example embodiment, the recording medium may include a memory storing instructions and a processor 210. The memory, when executed by the processor, may store instructions to cause the electronic device to: identify, based on pieces of feedback information corresponding to one or more hybrid automatic repeat request (HARQ) process IDs, a first data block determined not to perform HARQ retransmission (HARQ-less) among one or more data blocks; transmit, to the base station 400 using the first data block, data classified as not performing retransmission when at least one block is identified as the first data block; stop monitoring a physical downlink control channel (PDCCH) being executed for retransmitting the HARQ; and switch the electronic device 200 into a sleep state.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
memory storing instructions; and
at least one processor comprising processing circuitry,
wherein the instructions, when executed by at least one processor, individually or in any combination, cause the electronic device to:
identify, based on feedback information corresponding to one or more hybrid automatic repeat request (HARQ) process IDs, a first data block determined not to perform HARQ retransmission (HARQ-less) among one or more data blocks,
transmit, to a base station using the first data block, data classified as not performing retransmission based on at least one block being identified as the first data block, and
stop monitoring a physical downlink control channel (PDCCH) being executed for retransmitting the HARQ and switch the electronic device into a sleep state.

2. The electronic device of claim 1, wherein the feedback information corresponding to the one or more HARQ process IDs includes identification information indicating whether to retransmit the HARQ for each HARQ process ID,
the identification information is generated by the electronic device or received via any one of a base station or a network,
based on the first data block being identified, multiplexing and assembling extended reality (XR)-related data in a logical channel buffer, and
the multiplexed and assembled data is transmitted to any one of the base station or the network via the first data block.

3. The electronic device of claim 2, wherein the instructions, when executed by at least one processor, individually or in any combination, cause the electronic device to:
compare an ID of the data block with the identification information whenever the data block is generated to identify whether the data block is a block determined not to perform the HARQ retransmission,
identify a second data block that perform the HARQ retransmission,
multiplex and assemble remaining data unrelated to the extended reality (XR) based on the second data block being identified,
transmit the multiplexed and assembled data to the base station via the second data block, and
perform PDCCH monitoring.

4. The electronic device of claim 1, wherein the instructions, when executed by as least one processor, individually or in any combination, cause the electronic device to:
match the HARQ process ID to each unit of each data block among the one or more data blocks,
generate identification information using a flag indicating whether the HARQ is retransmitted for each HARQ process ID,
confirm whether the data block is a data block determined not to perform retransmission based on the identification information, and
transmit the first data block and not transmit HARQ feedback for retransmission to the base station, based on the confirmation that any one block is the first data block determined not to perform retransmission.

5. The electronic device of claim 2, wherein the electronic device is configured to:
receive, from the base station via the network, the identification information in which whether the HARQ is retransmitted for each process ID is written, and
transmit the identification information using a media access control (MAC)-control element (CE) of the MAC layer or downlink control information (DCI) of a physical layer.

6. The electronic device of claim 2, wherein the electronic device is configured to:
generate identification information in which whether HARQ is retransmitted for each process ID is written,
transmit a data block to be transmitted to the base station based on the generated identification information, and
wherein the identification information is transmitted using a media access control (MAC)-control element (CE) of the MAC layer or uplink control information (UCI) of a physical layer.

7. The electronic device of claim 1, wherein the instructions, when executed by at least one processor, individually or in any combination, cause the electronic device to:
transmit a message to the base station indicating that the data block transmitted during a specified time is a data block that does not perform HARQ retransmission, and
switch into the sleep state after the transmission of the first data block that does not perform the HARQ retransmission.

8. The electronic device of claim 1, wherein the electronic device is configured to:
distinguish first data related to extended reality (XR) and second data unrelated to the extended reality (XR),
determine a logical channel matching the distinguished data,
multiplex and assemble the first data into a data block determined not to perform retransmission, and
pad an empty space of the data block by inserting a specific bit or byte based on the first data related to the extended reality (XR) no longer remaining on the logical channel.

9. The electronic device of claim 8, wherein the electronic device is configured to transmit the data block determined not to perform the retransmission, switch the electronic device into the sleep state, and stop the PDCCH monitoring.

10. The electronic device of claim 2, wherein the electronic device is configured to:
distinguish first data related to extended reality and second data unrelated to the extended reality (XR),
determine a logical channel matching the distinguished data,
multiplex and assemble the second data into a second data block, and pad an empty space of the data block by inserting a specific bit or byte based on the second data unrelated to the extended reality (XR) no longer remaining on the logical channel.

11. The electronic device of claim 10, wherein the electronic device is configured to:
transmit the second data to the base station using the second data block,
perform PDCCH monitoring to receive HARQ feedback information for retransmission from the base station, and maintain the electronic device in an active state.

12. A method of operating an electronic device, comprising:
identifying, based on feedback information corresponding to one or more hybrid automatic repeat request (HARQ) process IDs, a first data block determined not to perform HARQ retransmission (HARQ-less) among one or more data blocks;
transmitting, to a base station using the first data block, data classified as not performing retransmission based on at least one block being identified as the first data block; and
stopping monitoring a physical downlink control channel (PDCCH) being executed for retransmitting the HARQ and switching the electronic device into a sleep state.

13. The method of claim 12, wherein the feedback information corresponding to the one or more HARQ process IDs includes identification information indicating whether to retransmit the HARQ for each HARQ process ID,
the identification information is generated by the electronic device or received via any one of a base station or a network, and
the method further comprises:
multiplexing and assembling extended reality (XR)-related data in a logical channel buffer based on the first data block being identified, and
transmitting the multiplexed and assembled data to any one of the base station or the network via the first data block.

14. The method of claim 13, further comprising:
comparing an ID of the data block with the identification information whenever the data block is generated to identify whether the data block is a block determined not to perform the HARQ retransmission;
identifying a second data block that performs the HARQ retransmission;
multiplexing and assembling remaining data unrelated to the extended reality (XR) based on the second data block being identified;
transmitting the multiplexed and assembled data to the base station via the second data block; and
performing PDCCH monitoring.

15. The method of claim 12, further comprising:
matching the HARQ process ID to each unit of each data block among the one or more data blocks; and
generating identification information using a flag indicating whether the HARQ is retransmitted for each HARQ process ID;
confirming whether the data block is a data block determined not to perform retransmission based on the identification information; and
transmitting the first data block and not transmitting HARQ feedback for retransmission to the base station, based on the confirmation that any one block is the first data block determined not to perform retransmission.

16. The method of claim 13, further comprising:
receiving, from a base station via the network, identification information in which whether the HARQ is retransmitted for each process ID is written,
wherein the identification information is transmitted using a media access control (MAC)-control element (CE) of the MAC layer or downlink control information (DCI) of a physical layer.

17. The method of claim 13, further comprising:
transmitting a message to the base station indicating that the data block transmitted during a specified time is a data block that does not perform the HARQ retransmission; and
switching the electronic device into the sleep state after the transmission of the data block that does not perform the HARQ retransmission.

18. The method of claim 12, further comprising:
distinguishing first data related to extended reality (XR) and second data unrelated to the extended reality (XR);
determining a logical channel matching the distinguished data;
multiplexing and assembling the first data into a data block determined not to perform retransmission, and
padding an empty space of the data block by inserting a specific bit or byte based on the first data related to the extended reality (XR) no longer remaining on the logical channel.

19. A non-transitory computer-readable recording medium, comprising:
a memory storing instructions; and
at least one processor comprising processing circuitry,
wherein the instructions, when executed by at least one processor, of the electronic device, individually or in any combination, cause the electronic device to
identify, based on feedback information corresponding to one or more hybrid automatic repeat request (HARQ) process IDs, a first data block determined not to perform HARQ retransmission (HARQ-less) among one or more data blocks,
transmit, to a base station using the first data block, data classified as not performing retransmission when at least one block is identified as the first data block, and
stop monitoring a physical downlink control channel (PDCCH) being executed for retransmitting the HARQ and switch the electronic device into a sleep state.

20. The non-transitory computer-readable recording medium of claim 19, wherein the instructions, when executed by at least one processor, individually or in any combination, cause the electronic device to:
include, in the feedback information corresponding to the one or more HARQ process IDs, identification information indicating whether the HARQ is transmitted for each HARQ process ID, the identification information being generated by the electronic device or received from any one of a base station or a network,
multiplex and assemble extended reality (XR)-related data in a logical channel buffer based on the first data block being identified, and
transmit the multiplexed and assembled data to any one of the base station or the network via the first data block.
